(19) United States
(12) Patent Application Publication
(10) Pub. No.: US 2015/0222701 A1
(43) Pub. Date: Aug. 6, 2015

(54) METHOD AND SYSTEMS FOR SYNCING CONTACTS ON MULTIPLE DEVICES

(71) Applicant: VONAGE NETWORK LLC, Holmdel, NJ (US)

(72) Inventor: Boaz Zehavi, Jersey City, NJ (US)

(21) Appl. No.: 14/169,231

(22) Filed: Jan. 31, 2014

(51) Int. Cl. H04L 29/08

(52) U.S. Cl. CPC H04L 67/1095

(57) ABSTRACT

Methods and systems for synchronizing contact information across multiple devices associated with a user are provided herein. In some embodiments, a method for synchronizing contact information across multiple devices associated with a user may include receiving native address book information from a first native address book stored on a first device associated with the user, synchronizing a first address book stored on a network storage device using the native address book information received, such that the first address book includes only contact information included in the first native address book, and synchronizing a cloud address book associated with the user stored on the network storage device using the native address book information received, wherein the cloud address book includes contact information from a plurality of devices associated with the user.

### BACKGROUND

1. Field

Embodiments of the present invention generally relate to methods and systems for synchronizing (“syncing”) contacts across multiple devices associated with a user.

2. Description of the Related Art

An address book function, or contact directory, may include contact information about numerous contacts. Contact information generally includes information that can be used for contacting, corresponding with or otherwise communicating with a contact. Contact information may include, for example, the names, telephone numbers, e-mail addresses, mailing addresses, and other identifying information of a contact.

Typically, a user may be associated with, or otherwise have access to multiple devices, with each device having its own native address book/contact directory. In addition, applications installed on each device may each maintain a separate contact directory specific to the application. The large variety of disparate address books/contact directories that are associated with the various applications and devices can make it difficult for users to quickly access all of the available contact information that corresponds to a particular contact. This is particularly true when considering that some of the disparate contact directories contain different contact information.

Thus, there is a need for a method and apparatus to provide a better way of synchronizing contact information across multiple devices associated with a user.

### SUMMARY

Methods and systems for synchronizing contact information across multiple devices associated with a user are provided herein. In some embodiments, a method for synchronizing contact information across multiple devices associated with a user may include receiving native address book information from a first native address book stored on a first device associated with the user, synchronizing a first address book stored on a network storage device using the native address book information received, such that the first address book includes only contact information included in the first native address book, and synchronizing a cloud address book associated with the user stored on the network storage device using the native address book information received, wherein the cloud address book includes contact information from a plurality of devices associated with the user.

In some embodiments, a method for synchronizing contact information across multiple devices associated with a user may include receiving native address book information from a first native address book stored on a first device associated with the user, and synchronizing a cloud address book associated with the user stored on a network storage device using the native address book information received and address books associated with contacts included in the first native address book, wherein the cloud address book includes contact information from a plurality of devices associated with the user.

In some embodiments, a system for synchronizing contact information across multiple devices associated with a user may include a contact storage device that stores a cloud address book associated with the user, and one remote address book for each of the plurality of devices associated with a user, wherein each remote address book includes native address book information from a corresponding one of the plurality of devices; and a contact synchronization module configured to receive native address book information from each of the plurality of devices associated with a user, synchronize each of the remote address books using the native address book information received, such that each remote address book includes only contact information from a corresponding native address book; and synchronize the cloud address book using the native address book information received from each of the plurality of devices associated with a user.

Other and further embodiments of the present invention are described below.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 depicts a block diagram of a telecommunication network, according to one or more embodiments of the invention;

FIG. 2 depicts a block diagram of a system for synchronizing contact information across multiple devices associated with a user, according to one or more embodiments of the invention;

FIG. 3 is a bubble chart of operations of a system for synchronizing contact information across multiple devices associated with a user, according to one or more embodiments of the invention;

FIG. 4 depicts a flow diagram of a method for synchronizing contact information across multiple devices associated with a user, according to one or more embodiments of the invention;

FIG. 5 depicts a computer system that can be utilized in various embodiments of the present invention, according to one or more embodiments of the invention.

To facilitate understanding, identical reference numerals have been used, where possible, to designate identical elements that are common to the figures. The figures are not drawn to scale and may be simplified for clarity. It is contemplated that elements and features of one embodiment may be beneficially incorporated in other embodiments without further recitation.

### DETAILED DESCRIPTION

Embodiments of the present invention generally relate to methods and systems for synchronizing contact information across multiple devices associated with a user. More specifically, embodiments of the present invention facilitate the synchronization and management of contact information stored on disparate multiple devices associated with a user using a configurable network based address book/contact directory associated with a user that is accessible from the multiple devices. The ability to sync contacts across devices advantageously provides users with a seamless contact information experience on each device where they login. That is, embodiments of the present invention allows a user to use same address book across devices, and the ability to obtain consistent access to caller ID information for incoming and outgoing calls/communications on any device they are using. As used herein, synchronizing contact information/address books includes updating/modifying contact information, adding contact information, removing/deleting contact information, and the like.

For example, user X may own, or otherwise have access to, device A and device B, each of which have a unique native address book (e.g., native contacts A and native contacts B). The same mobile app, for example a Voice over Internet Protocol (VOIP) telecommunication app, may be installed on both devices. The native contact information stored on each device is sent to a network based contact management system (CMS). In some embodiments, the CMS may separately store each device's contact information (i.e., in separate address books) and also store a combined “cloud contact book” for user X that may include at least some contacts from each of native contacts A and/or native contacts B. Thus, when user X accesses the mobile app on each device, they will have access to the local native address book and also to the network “cloud address book.” The native address books and the “cloud address book” may be synced in various different ways as will be described below in further detail. In addition, embodiments consistent with the present invention address privacy issues associated with guest access to devices and the synchronization of guest cloud address books with a native address book as will be described below in further detail.

Some portions of the detailed description which follow are presented in terms of operations on binary digital signals stored within a memory of a specific apparatus or special purpose computing device or platform. In the context of this particular specification, the term specific apparatus or the like includes a general purpose computer once it is programmed to perform particular functions pursuant to instructions from program software. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

Some exemplary embodiments described below are with respect to a mobile Voice over Internet Protocol (VOIP) telecommunication app. However, one skilled in the art will readily recognize from the following description that any application that relies on or uses address books/contact directories may be used in embodiments consistent with the present invention without departing from the principles of the disclosure described herein.

In the following description, the terms VOIP system, VOIP telephony system, IP system and IP telephony system are all intended to refer to a system that connects callers and that delivers data, text and video communications using Internet protocol data communications. Those of ordinary skill in the art will recognize that embodiments of the present invention are not limited to use with IP telephony systems and may also be used in other systems.

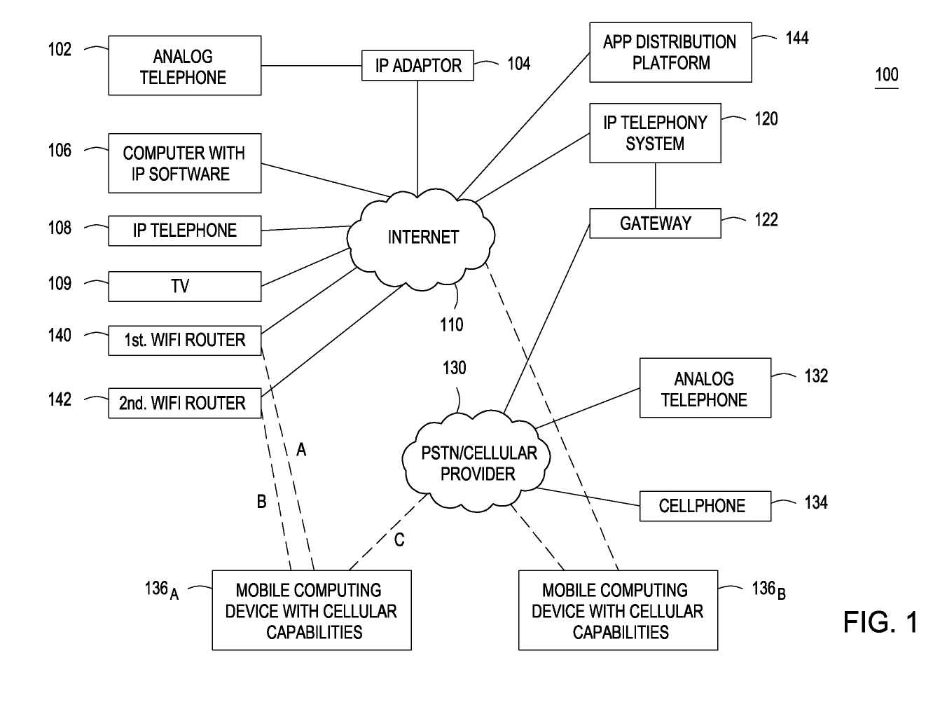

As illustrated in FIG. 1, a communications environment 100 is provided to facilitate IP enhanced communications. An IP telephony system 120 enables connection of telephone calls between its own customers and other parties via data communications that pass over a data network 110. The data network 110 is commonly the Internet, although the IP telephony system 120 may also make use of private data networks. The IP telephony system 120 is connected to the Internet 110. In addition, the IP telephony system 120 is connected to a publicly switched telephone network (PSTN) 130 via a gateway 122. The PSTN 130 may also be directly coupled to the Internet 110 through one of its own internal gateways (not shown). Thus, communications may pass back and forth between the IP telephony system 120 and the PSTN 130 through the Internet 110 via a gateway maintained within the PSTN 130.

The gateway 122 allows users and devices that are connected to the PSTN 130 to connect with users and devices that are reachable through the IP telephony system 120, and vice versa. In some instances, the gateway 122 would be a part of the IP telephony system 120. In other instances, the gateway 122 could be maintained by a third party.

Customers of the IP telephony system 120 can place and receive telephone calls using an IP telephone 108 that is connected to the Internet 110. Such an IP telephone 108 could be connected to an Internet service provider via a wired connection or via a wireless router. In some instances, the IP telephone 108 could utilize a packet-switched network of a cellular telephone system to access the Internet 110.

Alternatively, a customer could utilize an analog telephone 102 which is connected to the Internet 110 via a telephone adapter 104. The telephone adapter 104 converts analog signals from the telephone 102 into data signals that pass over the Internet 110, and vice versa. Analog telephone devices include but are not limited to standard telephones and document imaging devices such as facsimile machines. A configuration using a telephone adapter 104 is common where the analog telephone 102 is located in a residence or business. Other configurations are also possible where multiple analog telephones share access through the same IP adaptor. In those situations, all analog telephones could share the same telephone number, or multiple communication lines (e.g., additional telephone numbers) may provisioned by the IP telephony system 120.

In addition, a customer could utilize a soft-phone client running on a computer 106 or a television 109 to place and receive IP based telephone calls, and to access other IP telephony systems (not shown). The computer 106 may be a personal computer (PC), a tablet device, a gaming system, and the like. In some instances, the soft-phone client could be assigned its own telephone number. In other instances, the soft-phone client could be associated with a telephone number that is also assigned to an IP telephone 108, or to a telephone adaptor 104 that is connected one or more analog telephones 102.

Users of the IP telephony system 120 are able to access the service from virtually any location where they can connect to the Internet 110. Thus, a customer could register with an IP telephony system provider in the U.S., and that customer could then use an IP telephone 108 located in a country outside the U.S. to access the services. Likewise, the customer could also utilize a computer outside the U.S. that is running a soft-phone client to access the IP telephony system 120.

A third party using an analog telephone 132 which is connected to the PSTN 130 may call a customer of the IP telephony system 120. In this instance, the call is initially connected from the analog telephone 132 to the PSTN 130, and then from the PSTN 130, through the gateway 122 to the IP telephony system 120. The IP telephony system 120 then routes the call to the customer's IP telephony device. A third party using a cellular telephone 134 could also place a call to an IP telephony system customer, and the connection would be established in a similar manner, although the first link would involve communications between the cellular telephone 134 and a cellular telephone network. For purposes of this explanation, the cellular telephone network is considered part of the PSTN 130.

In the following description, references will be made to an “IP telephony device.” This term is used to refer to any type of device which is capable of interacting with an IP telephony system to complete an audio or video telephone call or to send and receive text messages, and other forms of communications. An IP telephony device could be an IP telephone, a computer running IP telephony software, a telephone adapter which is itself connected to a normal analog telephone, or some other type of device capable of communicating via data packets. An IP telephony device could also be a cellular telephone or a portable computing device that runs a software application that enables the device to act as an IP telephone. Thus, a single device might be capable of operating as both a cellular telephone that can facilitate voice based session calls, and an IP telephone that can facilitate data based session calls.

The following description will also refer to a mobile telephony device. The term “mobile telephony device” is intended to encompass multiple different types of devices. In some instances, a mobile telephony device could be a cellular telephone. In other instances, a mobile telephony device may be a mobile computing device, such as the APPLE IPHONE, that includes both cellular telephone capabilities and a wireless data transceiver that can establish a wireless data connection to a data network. Such a mobile computing device could run appropriate application software to conduct VoIP telephone calls via a wireless data connection. Thus, a mobile computing device, such as an APPLE IPHONE, a RIM BLACKBERRY or a comparable device running GOOGLE ANDROID operating system could be a mobile telephony device.

In still other instances, a mobile telephony device may be a device that is not traditionally used as a telephony device, but which includes a wireless data transceiver that can establish a wireless data connection to a data network. Examples of such devices include the APPLE IPOD TOUCH and the IPAD. Such a device may act as a mobile telephony device once it is configured with appropriate application software.

FIG. 1 illustrates that a mobile computing device with cellular capabilities 136A (e.g., a smartphone) is capable of establishing a first wireless data connection A with a first wireless access point 140, such as a WiFi or WiMax router. The first wireless access point 140 is coupled to the Internet 110. Thus, the mobile computing device 136A can establish a VOIP telephone call with the IP telephony system 120 via a path through the Internet 110 and the first wireless access point 140.

FIG. 1 also illustrates that the mobile computing device 136A can establish a second wireless data connection B with a second wireless access point 142 that is also coupled to the Internet 110. Further, the mobile computing device 136A can establish either a third wireless data connection C via a packet-switch network provided by a cellular service provider 130 using its cellular telephone capabilities, or establish a voice based session telephone call via a circuit-switched network provided by a cellular service provider 130. The mobile computing device 136A could also establish a VoIP telephone call with the IP telephony system 120 via the second wireless connection B or the third wireless connection C.

Although not illustrated in FIG. 1, the mobile computing device 136A may be capable of establishing a wireless data connection to a data network, such as the Internet 110, via alternate means. For example, the mobile computing device 136A might link to some other type of wireless interface using an alternate communication protocol, such as the WIMAX standard.

Similarly, mobile computing device with cellular capabilities 136B may also be coupled to internet 110 and/or cellular service provider 130. In some embodiments, mobile computing device 136B may be connected to internet 110 via a WIFI or WIMAX connection, and the like, and can also establish a VOIP telephone calls with the IP telephony system 120 similar to mobile computing device 136A. In embodiments of the present invention, communications environment 100 may be used to establish voice based or data based telecommunications sessions between mobile computing device 136A and mobile computing device 136B, depending on various criteria associated with each of the mobile computing devices, as will be described below in more detail.

In the embodiments described above, a device may act as a mobile telephony device once it is configured with appropriate application software that may be downloaded from an app distribution platform 144. For example, mobile computing device 136A may download a VOIP mobile app from app distribution platform 144 and install the VOIP mobile app on mobile computing device 136A.

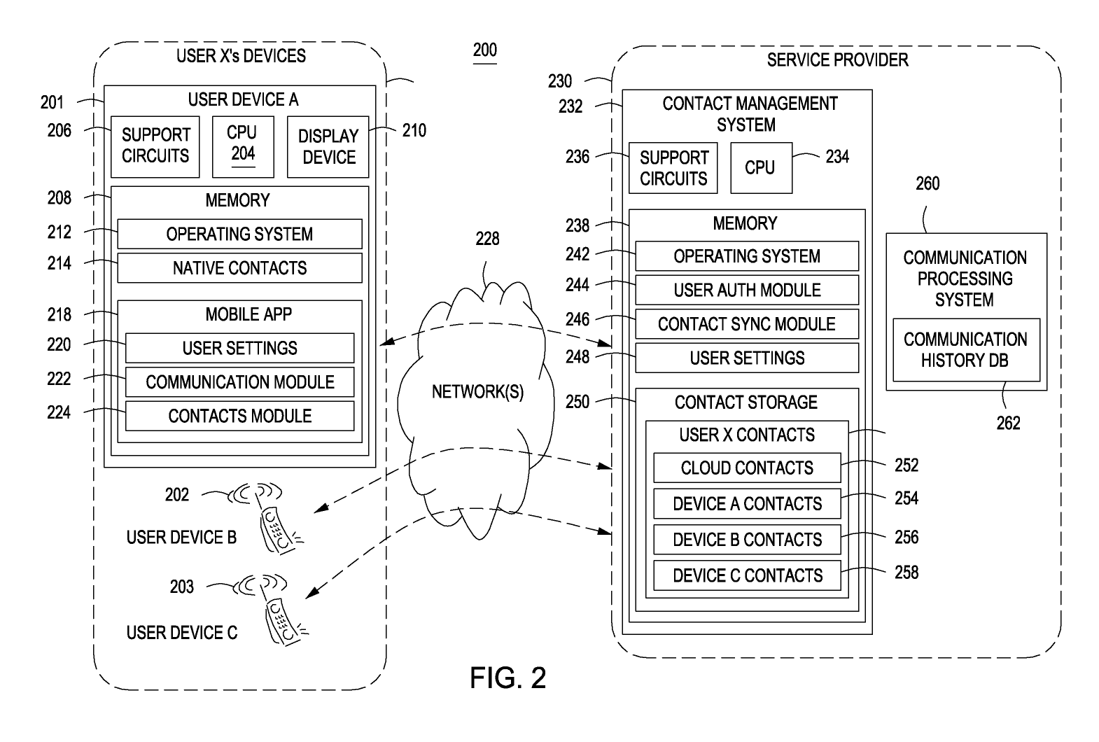

FIG. 2 depicts a block diagram of a system 200 for synchronizing contact information across multiple devices associated with a user, according to one or more embodiments. The system 200 comprises multiple user devices, such as user devices 201, 202 and 203, and service provider system 230 communicatively coupled via networks 228. In some embodiments, user devices 201, 202 and 203 may be mobile computing devices (e.g., 136A) associated with a user, and service provider system 230 may be IP telephony system 120 as described above in FIG. 1.

Each user device 201, 202 and 203 may comprise a Central Processing Unit (CPU) 204, support circuits 206, memory 208, and a display device 210. The CPU 204 may comprise one or more commercially available microprocessors or microcontrollers that facilitate data processing and storage. The various support circuits 206 facilitate the operation of the CPU 204 and include one or more clock circuits, power supplies, cache, input/output device and circuits, and the like. The memory 208 comprises at least one of Read Only Memory (ROM), Random Access Memory (RAM), disk drive storage, optical storage, removable storage and/or the like. In some embodiments, the memory 208 comprises an operating system 212, native contacts 214 and a mobile app 218, such as a mobile telecommunication app.

The operating system (OS) 212 generally manages various computer resources (e.g., network resources, file processors, and/or the like). The operating system 212 is configured to execute operations on one or more hardware and/or software modules, such as Network Interface Cards (NICs), hard disks, virtualization layers, firewalls and/or the like. Examples of the operating system 212 may include, but are not limited to, various versions of LINUX, MAC OSX, BSD, UNIX, MICROSOFT WINDOWS, IOS, ANDROID and the like. In some embodiments, operating system 212 may include an application programming interface (API) which can be used to access and user device information and features (such as, for example, by mobile app 218).

The mobile app 218 may be any app the uses address book information. In some embodiments, the mobile app 218 is a VoIP app that provides over-the-top (OTT) VoIP telephony services to an end-user. In some embodiments, an end-user may download the mobile app 218 from service provider system 230, or from an app distribution system 144, and install the mobile app 218 on their device. Although the mobile app 218 is described herein as a separate stand-alone application, in some embodiments the mobile app 218 may be integrated into OS 212, and may use existing API calls provided by the OS 212 to access or control various features of user devices 202.

In some embodiments mobile app 218 may include user settings 220, a communication module, and a contacts module. In some embodiments, the user settings 220 may be used to determine how a user would like contact information synchronized or displayed, and may be used to manage privacy settings for the user (i.e., control which contacts will be synchronized with the contact management system 232). Communication module 222 may be used to facilitate, otherwise provide, communication services such as, for example, voice or video calling, SMS messages, email, or various other types of communication services provided by a service provider 230. In some embodiments, the contacts module 224 may be used to help manage, synchronize and display local and network contact information (i.e., an address book) and also to interface/communicate with a remote contact management system, such as, for example, contact management system 232. In some embodiments, communication module 222 and contacts module 224 may encrypt all or a portion of the information sent to remote servers/systems over network 228, or otherwise transmit the information in a secure format.

The networks 228 comprise one or more communication systems that connect computers by wire, cable, fiber optic and/or wireless link facilitated by various types of well-known network elements, such as hubs, switches, routers, and the like. The networks 228 may include an Internet Protocol (IP) network (such as internet 110 of FIG. 1), a public switched telephone network (PSTN) (such as the PSTN network of PSTN provider 130 of FIG. 1), or other mobile communication networks, and may employ various well-known protocols to communicate information amongst the network resources.

In some embodiments, service provider system 230 may be a communication service provider, such as a VoIP service provider, that includes and maintains contact management system 232. In other embodiments, contact management system 232 may be a separate entity that provides contact management services to service provider system 230, or to individual users, by agreement. Service provider system 230 may include contact management system 232 that may be used to manage/synchronize contacts across multiple devices associated with a user. The contact management system 232 may include a Central Processing Unit (CPU) 234, support circuits 236, and memory 238. The CPU 234 may comprise one or more commercially available microprocessors or microcontrollers that facilitate data processing and storage. The various support circuits 236 facilitate the operation of the CPU 234 and include one or more clock circuits, power supplies, cache, input/output circuits, and the like. The memory 238 comprises at least one of Read Only Memory (ROM), Random Access Memory (RAM), disk drive storage, optical storage, removable storage and/or the like. In some embodiments, the memory 238 comprises an operating system 242, user authentication module 244, contact sync module 246, user settings 248, and contact storage 250. The operating system (OS) 242 generally manages various computer resources (e.g., network resources, file processors, and/or the like). The operating system 242 is configured to execute operations on one or more hardware and/or software modules, such as Network Interface Cards (NICs), hard disks, virtualization layers, firewalls and/or the like. Examples of the operating system 242 may include, but are not limited to, various versions of LINUX, MAC OSX, BSD, UNIX, MICROSOFT WINDOWS, 10S, ANDROID and the like.

In some embodiments, contact storage database 250 may store one or more address books for each user. For example, contact storage database 250 may associate user identification information (i.e., a user/account identifier) with one or more individual contacts or groups of contacts that form one or more address books associated with the user. For example, as depicted in FIG. 2, contact storage 250 may separately store user X's contacts/address books from user device A 201, user device B, 202, and user device C 203 as device A contacts 254, device B contacts, 256, and device C contacts 258. Additionally, contact storage 250 may store cloud contacts 252 that is a consolidated collection of one or more contacts from device A contacts 254, device B contacts, 256, and device C contacts 258. In addition, contact storage database 250 may include an identifier for indicating whether the contact is a subscriber/customer of the service provider system 230. For example, in a VoIP system (e.g., service provider system 230 is a VoIP system), each contact may be mark as “on-net” indicating that the contact is a subscriber of VoIP service provider, or “off-net” indicating that the contact is not a subscriber of the VoIP service provider. Database 250 may be any data structure or data source that maintains an association of contacts and user identifiers. The service provider system 230 may have direct or indirect access to database 250. For example, database 250 may exist on the service provider system 230 (direct access), or be accessible through a third party network (indirect access). For example, the service provider system 230 may be a VoIP service provider or a mobile app developer that provides OTT telephony services and may have agreements with trusted third-party providers to allow access to contact management system 232 and/or contact storage databases 250.

In some embodiments, service provider system 230 may also include a communication processing system 260. Communication processing system 260 may include a communication history database 262 that may be used by contact management system 232 to help manage a user's contacts. For example, in some embodiments, communication history information may be used to add or update contact information for a user.

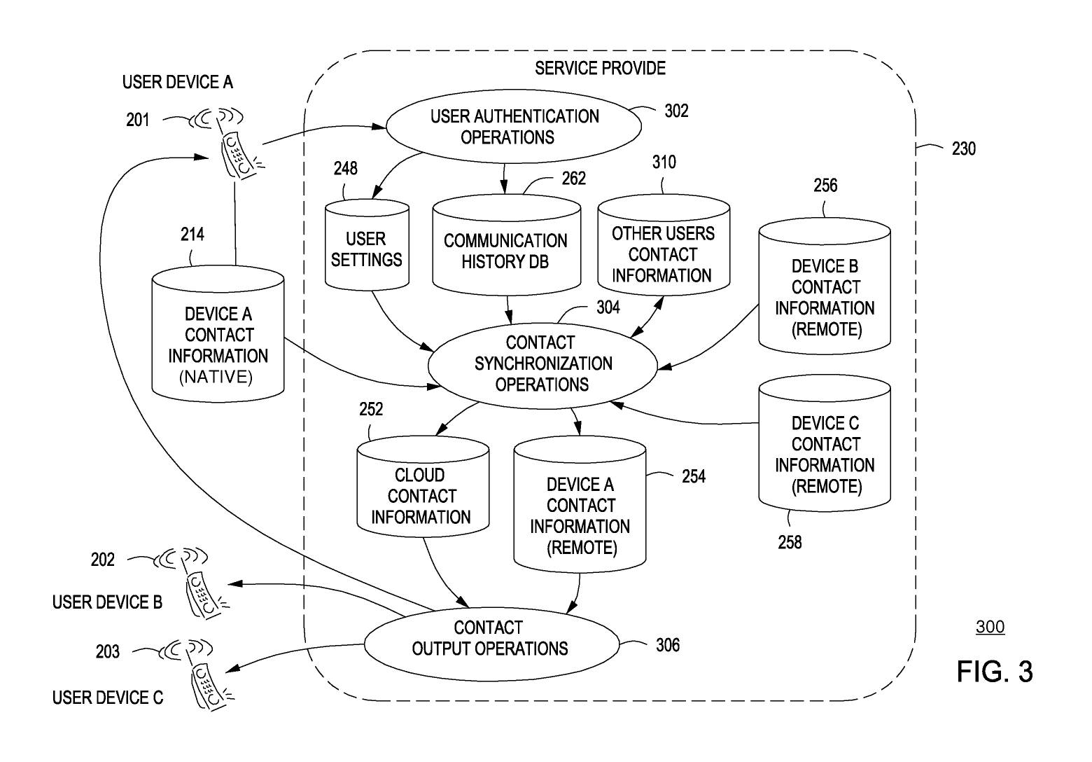

FIG. 3 is a bubble chart 300 of operations of system 200 for synchronizing contact information across multiple devices associated with a user in accordance with at least one embodiment of FIG. 2. In some embodiments, contact management services will be provided to users registered with server provider 230. In some embodiments, all registered users will be provided with contact management services, while in other embodiments, contact management services will be provided only to users who have opted into the service. In some embodiments, users may also be able to disable, or otherwise override, the contact management service at any time.

In operation, user X may use a mobile app 218 installed on user device A 201 to access service provider system 230 via network 228. User authentication operations 302 may be performed to determine and retrieve user X's user settings and contact information stored in the contact management system 232. In some embodiments, the user authentication operations 302 may be performed by user authentication module 244. Once user X is logged in, or otherwise authenticated, contact synchronization operations 304 may be performed by contact sync module 246. Contact synchronization operations 304 may use native contact information 214 stored on device A, device B contact information 256, device C contact information 258, communication history DB information 262, other user contact information 310, and user settings information 248 to update, manage and/or synchronize cloud contact information 252 and the remote device A contact information 254 stored in contact storage 250 in the contact management system 232, as described below in further detail.

The remote device A contact information 254 stored in contact storage 250 in the contact management system 232 may be updated by contact synchronization operations 304 using the native contact information 214 stored on device A such that an exact copy of device A's 201 native contact information 214 is stored as device A contact information 254 in contact storage 250 in the contact management system 232. In some embodiments, the remote copy of device A's 201 native contact information 214 stored in contact storage 250 may only be accessible when the user is accessing the service provider system 230 via device A 201. In other embodiments, the remote copy of device A's 201 native contact information 214 stored in contact storage 250 is accessible from any device that user X uses to access service provider system 230 using their user/account identifier. A user may configure access to the remote copy of device A's 201 native contact information 214 stored in contact storage 250 in user settings 220 and/or user settings 248.

In some embodiments, a user may opt-out from synchronization to one or more address books stored on the server. The user may opt-out from synchronizing all native contacts or for any specific group of native contacts based on how the user configures their user/privacy settings.

The cloud contact information 252 may be synchronized, or otherwise managed, by contact synchronization operations 304 in a number of different ways. First, in some embodiments, contact synchronization operations 304 may include synchronizing cloud contact information 252 with all of device A's 201 native contact information 214. Specifically, in some embodiments, contact synchronization operations 304 may update the cloud contact address book 252 to include all of device A's 201 native contact information 214. If the cloud contact address book 252 and device A's 201 native contact information 214 contain conflicting information for the same contact, contact synchronization operations 304 may merge all information, without deleting anything (e.g., if e-mail addresses are different, both addresses would be stored in the cloud contact information 252. In other embodiments, if the cloud contact address book 252 and device A's 201 native contact information 214 contain conflicting information for the “same contact”, the user may be prompted to clarify (e.g., make a selection) which contact information should be maintained. In some embodiments, the determination as to whether two sets of contact information may be related is performed using an algorithm that correlates one or more data fields, such as, for example, phone-number, name, company name, email, and the like.

In some embodiments, contact synchronization operations 304 may include synchronizing cloud contact information 252 with specific individual contacts included in device A's 201 native contact information 214 by user choice. Specifically, in some embodiments, contact synchronization operations 304 may include receiving selections from a user via contacts module 224 indicating specific contact information they wish to include in the cloud contact address book 252. For example, user X may “click” or select on the native contacts that he or she wants to update the cloud contact book with. Conflicts in contact information may be handled as discussed above.

In some embodiments, contact synchronization operations 304 may include updating/synchronizing cloud contact information 252 based on historical and current communication usage (i.e., syncing may occur according to incoming/outgoing call and message usage). For example, when user X uses mobile app 218 to call contact Y, then Y's contact information would be added to cloud contact book 252. In some embodiments, past communication history stored in communication history DB 262 may be analyzed to determine usage patterns and/or contact information. For example, each call/message initiated by user X may be considered user X's contact and may be added to cloud contact book 252. The historical communication information stored in communication history DB 262 may include any communications using device A 201, device B 202, or device C 203, communications using mobile app 218, other communication apps stored on a device associated with user X (e.g., an email or text message app stored on any of device A 201, device B 202, or device C 203), and the like.

In some embodiments, contact synchronization operations 304 may include the use of algorithms that will match a native address book's information with the communication information stored in communication history DB 262 for the user. If it is determined that there is contact information that matches, the contact would be synced between the native address book's information (e.g., device A's 201 native contact information 214) and the cloud contact information 252. Similarly, in some embodiments, current outgoing or incoming calls/messages may be matched by phone number, name, email, or any other identifying contact data to the native address book's information (e.g., device A's 201 native contact information 214). If it is determined that there is contact information that matches, the contact would be synced between the native address book's information (e.g., device A's 201 native contact information 214) and the cloud contact information 252.

In some embodiments, contact synchronization operations 304 may include updating/synchronizing cloud contact information 252 based on other users contact information. For example, contact synchronization operations 304 may include analyzing user X's contacts (either contacts from the various native address books or cloud contact information 252) and determining if contact information from the address books of any of user X's contacts is available (contacts of contacts). If contact information from the address books of any of user X's contacts is available, then only contacts that have at least some corresponding information in one of user X's 1^{st}, 2^{nd}, 3^{rd}, etc. level of contacts will be synchronized. Specifically, as user X logs into different devices, user X may not want their cloud address book synchronized with all contacts in the native address book of the device they logged into. Thus, in some embodiments, user X may specify that only contacts that can be verified through the contacts of user X's contacts. That is, user X may deem contacts that are at least partially verified in address books of user X's contacts may be considered safe to synchronize to their cloud address book. In some embodiments, user X may be able to specify how many levels of cloud contacts should be matched in user settings 218 and/or 248. For example, user X may specify that 3 levels of cloud contact should be analyzed. All of the contacts in the current cloud contact information 252 would be considered the first level of user X's contacts. To the extent the contact storage 250 of contact management system 232 stores the address book for any of user X's first level contacts in 310, each of those respective contacts would be considered second level contacts (i.e., contacts of contacts). Third level contacts would be considered contacts of the second level contacts.

Privacy settings stored in user settings 218 may provide the privacy/security settings as to whether a user's contact information and/or communication history may be shared with their contacts for use with the automatic synchronization systems and methods described above. For example, user Y may configure their privacy settings in their user settings 218 to indicate that they do not want their address book information shared with some or all of their contacts. Thus, embodiments consistent with the claimed invention advantageously provides customized privacy for a user that may want enhanced levels of privacy but still want to enjoy contact syncing features since it provides methods for synchronizing only real, relevant and safe contacts for the user.

As discussed above, there are multiple ways the cloud contact information 252 may be updated/synchronized using contact information stored in a user device's native address book. As user X accesses the service provider system 230 from different devices, contact management system may be synchronized accordingly using the native address book/contact information stored on the device used to access the service provider system 230. Contact output operations 306 may then be performed to provide access to the common cloud contact information 252 to user device A 201, user device B 202 and user device C 203 associated with user X, such that a seamless address book/contact information experience is provided to user X on each device where they login.

In some embodiments, a guest user (e.g., user Y) may access service provider system 230 using one of user X's devices. In those situations, privacy settings set by user X in user settings 220, and or privacy settings set by user Y in their user settings 248 stored in contact management system 232, may be used to specify if and how contacts should be synchronized.

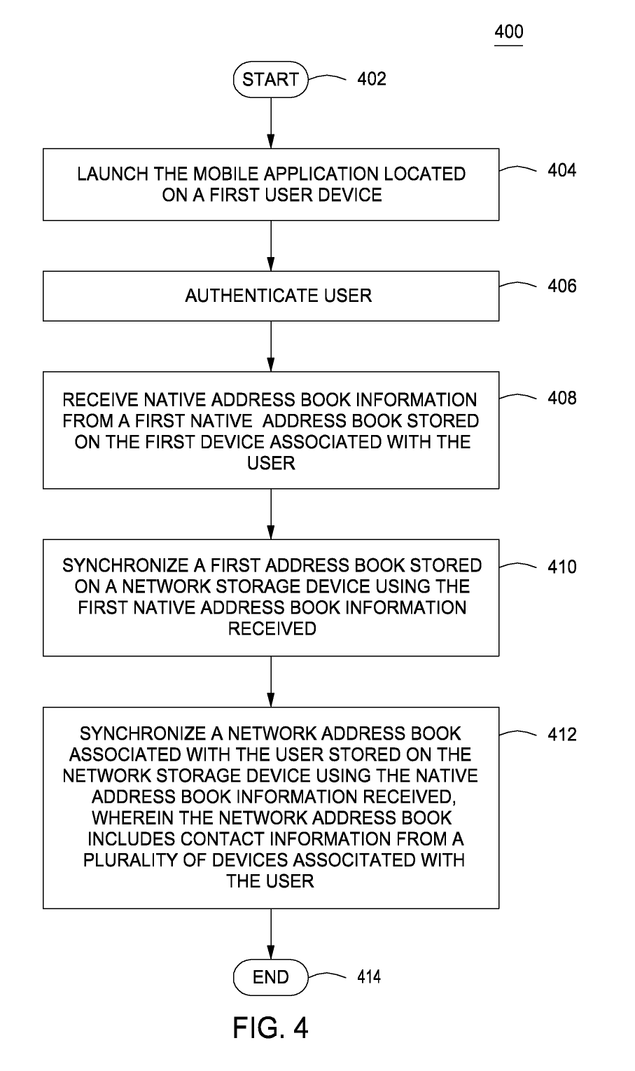

FIG. 4 depicts a flow diagram of a method 400 for synchronizing contacts across multiple devices associated with a user, according to one or more embodiments of the subject invention. The method begins at 402 and proceeds to 404 where a user launches an application, such as mobile app 218, on a first device associated with the user. Authentication information is sent to the system provider system 230 at 406 to authenticate the user. Once the user is authenticated, native address book information from a first native address book 214 stored on the first device 202 associated with the user is received at 408. At 410, a first address book stored on a network storage device may be synchronized using the native address book information received, such that the first address book includes only contact information included in the first native address book. At 412, a cloud address book associated with the user stored on the network storage device may be synchronized using the native address book information received, wherein the cloud address book includes contact information from a plurality of devices associated with the user. The method 400 ends at 414.

The embodiments of the present invention may be embodied as methods, apparatus, electronic devices, and/or computer program products. Accordingly, the embodiments of the present invention may be embodied in hardware and/or in software (including firmware, resident software, micro-code, and the like), which may be generally referred to herein as a “circuit” or “module”. Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device. These computer program instructions may also be stored in a computer-usable or computer-readable memory that may direct a computer or other programmable data processing apparatus to function in a particular manner, such that the instructions stored in the computer usable or computer-readable memory produce an article of manufacture including instructions that implement the function specified in the flowchart and/or block diagram block or blocks.

The computer-usable or computer-readable medium may be, for example but not limited to, an electronic, magnetic, optical, electromagnetic, infrared, or semiconductor system, apparatus or device. More specific examples (a non-exhaustive list) of the computer-readable medium include the following: hard disks, optical storage devices, magnetic storage devices, an electrical connection having one or more wires, a portable computer diskette, a random access memory (RAM), a read-only memory (ROM), an erasable programmable read-only memory (EPROM or Flash memory), an optical fiber, and a compact disc read-only memory (CD-ROM).

Computer program code for carrying out operations of the present invention may be written in an object oriented programming language, such as Java®, Smalltalk or C++, and the like. However, the computer program code for carrying out operations of the present invention may also be written in conventional procedural programming languages, such as the “C” programming language and/or any other lower level assembler languages. It will be further appreciated that the functionality of any or all of the program modules may also be implemented using discrete hardware components, one or more Application Specific Integrated Circuits (ASICs), or programmed Digital Signal Processors or microcontrollers.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the present disclosure and its practical applications, to thereby enable others skilled in the art to best utilize the invention and various embodiments with various modifications as may be suited to the particular use contemplated.

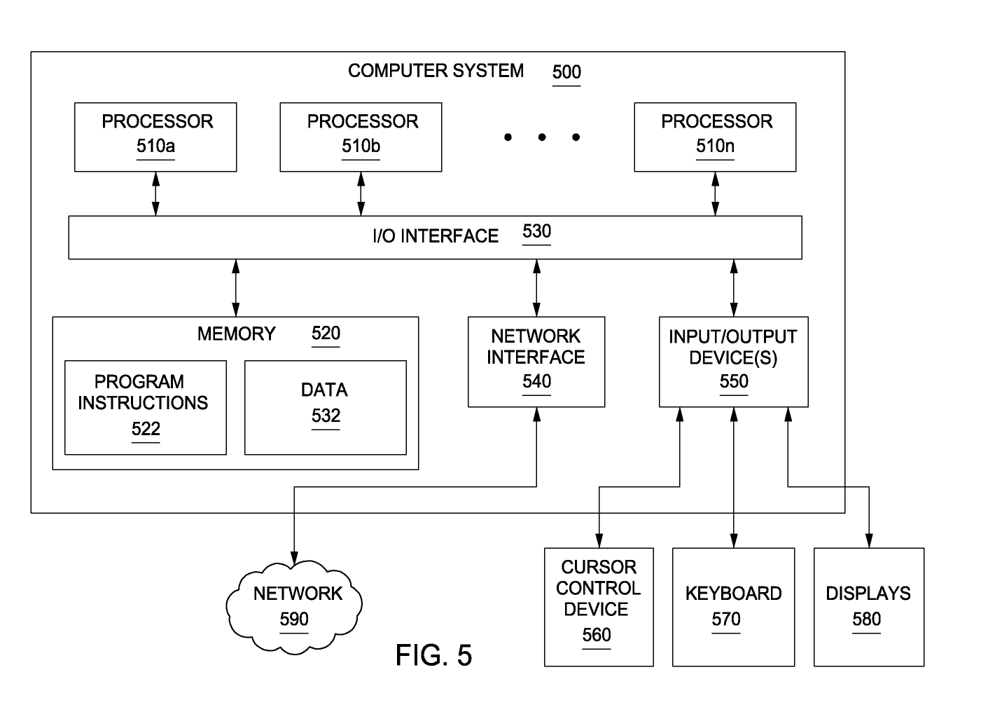

FIG. 5 depicts a computer system 500 that can be utilized in various embodiments of the present invention to implement the computer and/or the display, according to one or more embodiments.

Various embodiments of method and apparatus for organizing, displaying and accessing contacts in a contact list, as described herein, may be executed on one or more computer systems, which may interact with various other devices. One such computer system is computer system 500 illustrated by FIG. 5, which may in various embodiments implement any of the elements or functionality illustrated in FIGS. 1-4. In various embodiments, computer system 500 may be configured to implement methods described above. The computer system 500 may be used to implement any other system, device, element, functionality or method of the above-described embodiments. In the illustrated embodiments, computer system 500 may be configured to implement the operations in FIG. 3 and method 400 as processor-executable executable program instructions 522 (e.g., program instructions executable by processor(s) 510) in various embodiments.

In the illustrated embodiment, computer system 500 includes one or more processors 510a-510n coupled to a system memory 520 via an input/output (I/O) interface 530. Computer system 500 further includes a network interface 540 coupled to I/O interface 530, and one or more input/output devices 550, such as cursor control device 560, keyboard 570, and display(s) 580. In various embodiments, any of the components may be utilized by the system to receive user input described above. In various embodiments, a user interface may be generated and displayed on display 580. In some cases, it is contemplated that embodiments may be implemented using a single instance of computer system 500, while in other embodiments multiple such systems, or multiple nodes making up computer system 500, may be configured to host different portions or instances of various embodiments. For example, in one embodiment some elements may be implemented via one or more nodes of computer system 500 that are distinct from those nodes implementing other elements. In another example, multiple nodes may implement computer system 500 in a distributed manner.

In different embodiments, computer system 500 may be any of various types of devices, including, but not limited to, a personal computer system, desktop computer, laptop, notebook, or netbook computer, mainframe computer system, handheld computer, workstation, network computer, a camera, a set top box, a mobile device, a consumer device, video game console, handheld video game device, application server, storage device, a peripheral device such as a switch, modem, router, or in general any type of computing or electronic device.

In various embodiments, computer system 500 may be a uniprocessor system including one processor 510, or a multiprocessor system including several processors 510 (e.g., two, four, eight, or another suitable number). Processors 510 may be any suitable processor capable of executing instructions. For example, in various embodiments processors 510 may be general-purpose or embedded processors implementing any of a variety of instruction set architectures (ISAs). In multiprocessor systems, each of processors 510 may commonly, but not necessarily, implement the same ISA.

System memory 520 may be configured to store program instructions 522 and/or data 532 accessible by processor 510. In various embodiments, system memory 520 may be implemented using any suitable memory technology, such as static random access memory (SRAM), synchronous dynamic RAM (SDRAM), nonvolatile/Flash-type memory, or any other type of memory. In the illustrated embodiment, program instructions and data implementing any of the elements of the embodiments described above may be stored within system memory 520. In other embodiments, program instructions and/or data may be received, sent or stored upon different types of computer-accessible media or on similar media separate from system memory 520 or computer system 500.

In one embodiment, I/O interface 530 may be configured to coordinate I/O traffic between processor 510, system memory 520, and any peripheral devices in the device, including network interface 540 or other peripheral interfaces, such as input/output devices 550. In some embodiments, I/O interface 530 may perform any necessary protocol, timing or other data transformations to convert data signals from one component (e.g., system memory 520) into a format suitable for use by another component (e.g., processor 510). In some embodiments, I/O interface 530 may include support for devices attached through various types of peripheral buses, such as a variant of the Peripheral Component Interconnect (PCI) bus standard or the Universal Serial Bus (USB) standard, for example. In some embodiments, the function of I/O interface 530 may be split into two or more separate components, such as a north bridge and a south bridge, for example. Also, in some embodiments some or all of the functionality of I/O interface 530, such as an interface to system memory 520, may be incorporated directly into processor 510.

Network interface 540 may be configured to allow data to be exchanged between computer system 500 and other devices attached to a network (e.g., network 590), such as one or more external systems or between nodes of computer system 500. In various embodiments, network 590 may include one or more networks including but not limited to Local Area Networks (LANs) (e.g., an Ethernet or corporate network), Wide Area Networks (WANs) (e.g., the Internet), wireless data networks, some other electronic data network, or some combination thereof. In various embodiments, network interface 540 may support communication via wired or wireless general data networks, such as any suitable type of Ethernet network, for example; via telecommunications/telephony networks such as analog voice networks or digital fiber communications networks; via storage area networks such as Fiber Channel SANs, or via any other suitable type of network and/or protocol.

Input/output devices 550 may, in some embodiments, include one or more display terminals, keyboards, keypads, touchpads, scanning devices, voice or optical recognition devices, or any other devices suitable for entering or accessing data by one or more computer systems 500. Multiple input/output devices 550 may be present in computer system 500 or may be distributed on various nodes of computer system 500. In some embodiments, similar input/output devices may be separate from computer system 500 and may interact with one or more nodes of computer system 500 through a wired or wireless connection, such as over network interface 540.

In some embodiments, the illustrated computer system may implement any of the operations and methods described above, such as the operations described with respect to FIG. 3 and the methods illustrated by the flowcharts of FIG. 4. In other embodiments, different elements and data may be included.

Those skilled in the art will appreciate that computer system 500 is merely illustrative and is not intended to limit the scope of embodiments. In particular, the computer system and devices may include any combination of hardware or software that can perform the indicated functions of various embodiments, including computers, network devices, Internet appliances, PDAs, wireless phones, pagers, and the like. Computer system 500 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 500 may be transmitted to computer system 500 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium or via a communication medium. In general, a computer-accessible medium may include a storage medium or memory medium such as magnetic or optical media, e.g., disk or DVD/CD-ROM, volatile or non-volatile media such as RAM (e.g., SDRAM, DDR, RDRAM, SRAM, and the like), ROM, and the like.

The methods described herein may be implemented in software, hardware, or a combination thereof, in different embodiments. In addition, the order of methods may be changed, and various elements may be added, reordered, combined, omitted or otherwise modified. All examples described herein are presented in a non-limiting manner. Various modifications and changes may be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the example configurations may be implemented as a combined structure or component. These and other variations, modifications, additions, and improvements may fall within the scope of embodiments as defined in the claims that follow.

While the foregoing is directed to embodiments of the present invention, other and further embodiments of the invention may be devised without departing from the basic scope thereof, and the scope thereof is determined by the claims that follow.

1. A method for synchronizing contact information across multiple devices associated with a user, comprising:
receiving native address book information from a first native address book stored on a first device associated with the user;
synchronizing a first address book stored on a network storage device using the native address book information received, such that the first address book includes only contact information included in the first native address book; and
synchronizing a cloud address book associated with the user stored on the network storage device using the native address book information received, wherein the cloud address book includes contact information from a plurality of devices associated with the user.

2. The method of claim 1, wherein access to the cloud address book is provided to any of the plurality of devices associated with the user.

3. The method of claim 1, wherein synchronizing the cloud address book includes updating the cloud address book to include all of the native address book information stored on the first device.

4. The method of claim 1, wherein synchronizing the cloud address book includes:
receiving one or more selections from the first device indicating specific contact information included in the first native address book; and
updating the cloud address book to include the specific contact information indicated by the selections received.

5. The method of claim 1, wherein the cloud address book is further synchronized using communication usage information associated with the user.

6. The method of claim 5, wherein the communication usage information is one of real-time communication information or historical communication information stored in a communication history repository.

7. The method of claim 5, wherein synchronizing the cloud address book includes:
receiving contact information associated with an incoming or outgoing communication associated with the user; and
updating the cloud address book to include the contact information associated with the incoming or outgoing communication.

8. The method of claim 7, wherein the communication is one of a call, text message, email, or instant message.

9. The method of claim 7, wherein the contact information associated with the incoming or outgoing communication includes at least one of a caller identification (CID) name, a telephone number, or an e-mail address.

10. The method of claim 7, wherein the cloud address book is updated to only include contact information associated with the incoming or outgoing communication when the contact information associated with the incoming or outgoing communication matches at least a portion of the native address book information.

11. The method of claim 1, wherein the cloud address book is further synchronized using address books associated with contacts included in the first native address book.

12. The method of claim 11, wherein synchronizing the cloud address book includes:
determining that an address book associated with at least one first level contact included in the native address book information obtained is accessible; and
updating the cloud address book associated with the user to include contact information from the address book associated with the at least one first level contact.

13. The method of claim 12, wherein synchronizing the cloud address book further includes:
determining that an address book associated with at least one second level contact included in the address book associated with the at least one first level contact is accessible; and
updating the cloud address book associated with the user to include contact information from the address book associated with the at least one second level contact.

14. The method of claim 1, wherein access to the first address book and the cloud address book can be restricted to specific devices associated with the user.

15. The method of claim 1, further comprising:
receiving native address book information from a second native address book stored on a second device associated with the user;
synchronizing a second address book stored on a network storage device using the native address book information received, such that the second address book includes only contact information included in the second native address book; and
synchronizing the cloud address book associated with the user stored on the network storage device using the second native address book information obtained.

16. The method of claim 1, wherein an identifier is included for each contact included in the cloud address book that indicates whether a contact is a subscriber to a same communication service provider as the user.

17. A method for synchronizing contact information across multiple devices associated with a user, comprising:
receiving native address book information from a first native address book stored on a first device associated with the user; and
synchronizing a cloud address book associated with the user stored on a network storage device using the native address book information received and address books associated with contacts included in the first native address book, wherein the cloud address book includes contact information from a plurality of devices associated with the user.

18. The method of claim 17, wherein synchronizing the cloud address book includes:
determining that an address book associated with at least one first level contact included in the native address book information obtained is accessible; and
updating the cloud address book associated with the user to include contact information from the address book associated with the at least one first level contact.

19. A system for synchronizing contact information across a plurality of devices associated with a user, comprising:
a contact storage device that stores:
a cloud address book associated with the user, and
one remote address book for each of the plurality of devices associated with a user, wherein each remote address book includes native address book information from a corresponding one of the plurality of devices; and
a contact synchronization module configured to:
receive native address book information from each of the plurality of devices associated with a user,
synchronize each of the remote address books using the native address book information received, such that each remote address book includes only contact information from a corresponding native address book; and
synchronize the cloud address book using the native address book information received from each of the plurality of devices associated with a user.

20. The system of claim 19, further comprising:
a communication history database that stores communication usage history associated with the user.
